(19) United States
(12) Patent Application Publication
(10) Pub. No.: US 2007/0196601 A1
(43) Pub. Date: Aug. 23, 2007

(54) TEXTURED FILM WITH DEEP POCKETS

(75) Inventors: Carl Douglas Ray, Chesterfield, VA (US); Rickey James Seyler, Chesterfield, VA (US); Paul Eugene Thomas, Terre Haute, IN (US)

Correspondence Address: TROUTMAN SANDERS LLP, 600 PEACHTREE STREET , NE, ATLANTA, GA, 30308, US

(73) Assignee: TREDEGAR FILM PRODUCTS CORPORATION, RICHMOND, VA (US)

(21) Appl. No.: 11/674,850

(22) Filed: Feb. 14, 2007

Related U.S. Application Data
(60) Provisional application No. 60/774,456, filed on Feb. 17, 2006.

(51) Int. Cl. B32B 27/08; B29C 51/02; B29C 51/10

(52) U.S. Cl. 428/34.1; 428/35.7; 264/505; 264/571; 264/210.1

(57) ABSTRACT

A thermoplastic film having a first surface defining pockets, each pocket having a depth and breadth and a bottom, the bottom is preferably textured and is thinner than the thickness of the first surface. Devices made from the film include one or more of a variety of materials contained within the pockets and a second layer overlying the first surface to cover the openings of the pockets. A process of making the film is also disclosed.

### RELATED APPLICATION

This application claims the benefit of U.S. provisional application No. 60/774,456 filed Feb. 17, 2006 entitled Textured Film With Deep Pockets.

### FIELD OF INVENTION

The present invention relates to a textured film having deep pockets and more particularly to a thermoplastic film having deep pockets with a bottom surface that is textured

### BACKGROUND OF INVENTION

Textured thermoplastic films are generally known in the art. Texturing, which is typically achieved by an embossing process, is often used to reduce the gloss normally associated with thermoplastic films. The reduced gloss improves the aesthetics of the films and enhances its consumer appeal. Accordingly, such films have found application in limited use personal hygiene articles, such as feminine pads, diapers, and the like.

Embossing can also result in a lower adhesion of the film to a hard surface, which may be advantageous in packaging applications.

Vacuum formed films are also generally known in the art. Vacuum forming is a term used for a process in which a film is brought into contact with a forming structure, such as a screen, and subjected to vacuum pressure through the forming structure, whereby the vacuum pressure pulls the film material against the screen. If enough vacuum is applied, the film will rupture and form apertures. The vacuum forming process may be used with pre-manufactured films (in which case the process is termed a “re-heat” process because the film must be heated prior to being subjected to vacuum) or with a curtain of molten polymer (in which case the process is termed a “direct cast” process because the polymer curtain is cast directly onto the forming structure).

### SUMMARY OF THE INVENTION

The present invention provides a textured film which is conveniently manufactured using a vacuum forming process. The film comprises a three-dimensional thermoplastic film having a first surface defining a plurality of pockets. Land areas on the first surface are located between the pockets. The pockets have side walls depending from the first surface and a bottom surface spaced from the first surface. The thickness of the bottom surface is preferably less than the thickness of the film in the land areas. In a most preferred embodiment, the bottom surface of the pockets is textured. The film of the invention has application in a variety of uses.

For example, the textured film material of the invention can be used as a means for storage and delivery of an active substance. In such an embodiment, the pockets serve as reservoirs for the active substance. In such an embodiment, it is preferred to use a second layer overlying the first layer to help contain the active substance in the pockets prior to use. It may be preferable to release the active substance through the second layer, whereby the second layer could serve to meter the release of the active substance.

The active substance in such an application may be, for example, a cleaning agent, topical medicinal substance, skin lotion, sun tan lotion, solvent, or any other substance which is typically administered to a surface. Alternatively, or in addition, the active substance can be a reactive substance, scents, neutralizing agents, antimicrobial agents. Mixtures of such substances may also be employed. The active substance contained in the pockets can be in the form of a liquid, paste, gel, or solid, such as particulates.

In one embodiment, the user applies pressure to the pocket side for the system to push the active substance through the second layer. Alternatively, the user may apply sufficient force to the system such that the relatively thin bottom of the pockets rupture and release the active substance.

In another embodiment, the device is constructed to intake a material and the pockets may contain an absorbent material, such as, for example, a super absorbent polymer (“SAP”) or a neutralizing agent or antimicrobial agents or other reactive substance. If an absorbent material such as SAP is used, the device can be placed strategically in products such as diapers, feminine hygiene products, adult incontinent products and other disposable absorbent articles to maximize effectiveness and/or minimize bulk and cost.

In another embodiment, the active substance can be for lawn and garden applications. For example, the pockets may be filled with insecticides, herbicides and/or fertilizers and placed strategically to control pest and weed infestation or promote growth of desired plants.

Applicants also recognize that the textured material of the present invention may be used as a cushioning device. It has been found that the deep pockets, particularly when filled with fluids or fluid-like substances, such as air, gels or liquids, act as cushions and therefore can provide dampening or cushioning features to a structural element.

Accordingly, yet another aspect of the invention is an energy absorbing system in which the pockets, and preferably the substance they contain, absorb energy. In a preferred embodiment, the system comprises (a) a textured material having a first surface defining pockets; and (b) a second layer overlaying the first layer to encapsulate the pockets. In a preferred embodiment, the system further comprises a flooring material overlaying the textured material.

Yet another aspect of the invention is a method of making a textured film having a first surface defining pockets, each pocket having a bottom with a thickness less than that of the first surface. The process includes the steps of (1) providing a suction roll having a first tool defining voids and a second tool disposed within said first tool and defining a texture within said voids; and (2) contacting said web of polymeric film with said suction roll to draw said web onto said first and second tools, whereby the voids create pockets in a first surface of said web having a thickness, each pocket having a textured bottom created by said texture of said second tool, and wherein each bottom has a thickness less than the thickness of said first surface.

### BRIEF DESCRIPTION OF DRAWINGS

FIG. 1 shows a schematic of the textured film of the present invention.

FIG. 2 shows a cross-section of the textured film as seen along line A-A of FIG. 1.

FIG. 3 shows a schematic of a delivery system comprising the textured film of FIG. 1.

FIG. 4 shows a schematic of a production line for producing the textured film of FIG. 1.

FIG. 5 shows a section of the composite screen formed from two different tools.

### DETAILED DESCRIPTION

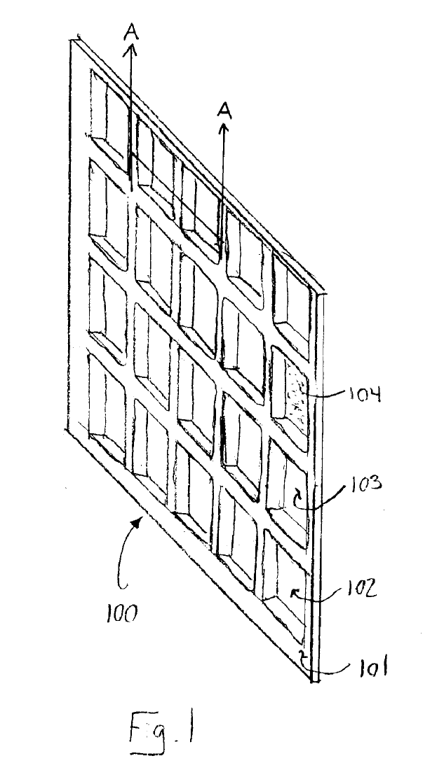

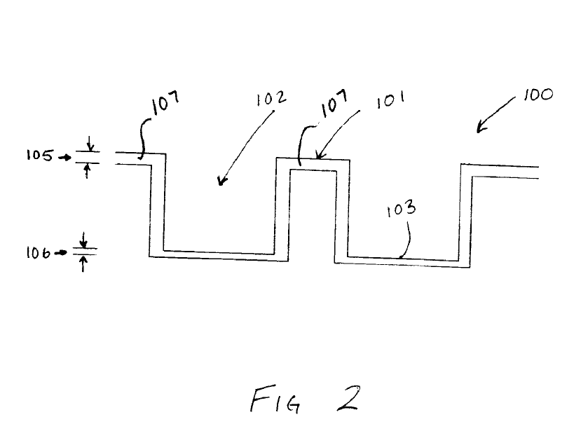

Referring to FIGS. 1 and 2, a preferred embodiment of the textured material 100 of the present invention is shown. The textured material 100 has a first surface 101 which defines pockets 102, each pocket 102 being separated from one another by land areas 107. As particularly seen in FIG. 2, each pocket 102 has a bottom 103 with a thickness 106, which less than the thickness of the film 105 in the land areas 107 at first surface 101. When the film is used to hold and release active substances, or as a cushioning layer, the size of the pockets 102 need to be sufficient to hold the desired amount of material.

The shape or configuration of the pockets 102 is not critical to the invention, and will largely be a function of the end use. It has been found that, in general, the pockets 102 can have a breadth of about 40 to about 200 mils, most preferably about 120 mils. The depth of the pockets can range from about 10 to about 50 mils, more preferably about 20-30 mils, and a depth of 25 mils being most preferred.

It has been found that having the bottom 103 thinner than that of the first surface 101 is advantageous. Applicants have developed a process in which the bottom 103 of the pocket 102 is made thinner during production of the material 100 through the use of suction rolls and screens. In such process, which is considered in greater detail below, the thickness of the bottom layer is inversely related to the depth of the pocket; i.e., as the depth of the pocket increases, the thickness of the pocket bottom decreases. Thus, no special actions need to be taken to achieve the thinner bottom surface 106 when using the process of the invention.

The thickness 105 of the land areas 107 on the first surface 101 of the film 100 can vary according to application and materials used. Suitable results have been found using a material thickness of about 1.5 to about 2 mils, and preferably about 1.75 mils. The thickness 106 of the bottom 103 of the pocket 102 again can vary according to application, although thicknesses ranging from about 0.2 to about 0.7 mils have been found to be suitable. The thinner bottom 103 may also facilitate a nearly complete release of the active substance from the pockets. It is understood that, depending on the stresses that the film may be subjected to when used in an energy absorbing device, the thinner bottom 103 may lead to premature rupture of the pocket and, thus, may not be desired. On the other hand, certain embodiments may take advantage of the ability of a thinner bottom 103 to rupture of degrade more quickly.

The surface 104 of the pocket bottom 103 may be textured to provide a z-direction delta on the surface 104. The surface 104 may be textured with depressions, dimples, bumps, ridges, or other types of surface aberrations. Although the amount of texturing can vary on the second surface 104, it has been found that a texture of about 20 to 60 aberrations per linear inch is generally sufficient. Preferably, the depth of the texturing on the second surface is no greater than about two-thirds the depth of the pocket, and, more preferably, no greater than one-half the depth of the pocket. In some embodiments, it may also be desired to form small apertures in the bottom 103 of the pockets to release an active substance in a pre-determined (e.g., aqueous) environment.

As mentioned above, the composition of film is not as important as its physical structure. Accordingly, providing that the film can be manipulated to have the physical structure described herein, Applicants have found that the film's chemical composition should be based primarily on processability considerations. For example, it is known in the art that films can be formed of a variety of resins, such as polyolefins (for example polyethylenes and polypropylenes); polyamides; polyesters; polyvinylchlorides; and polyacrylic acids. If a compostable or biodegradable film is desired, appropriate materials such as polylactic acid or starch containing blends and copolymers can be employed. Suitable resins are known to those skilled in the art for such applications.

Aside from processability considerations, it may be preferable to use materials which have desired vapor transmission properties, such as if the film is to be used to package an aromatic substance or a substance that needs to release certain gasses, such as nitrogen, hydrogen, etc. Films made from polyacrylic acids and polyesters are known to be highly vapor impervious. Thus, they would likely prevent the release of scents or gases and, therefore, are not particularly preferred for use in certain embodiments.

For many applications, polyolefin will be the resin of choice, most particularly polyethylene resin because of its ease of processability. Applicants have found a polyolefin blend, specifically a resin blend comprising 80% low density polyethylene (LDPE) and 20% high density polyethylene (HDPE), performs quite well in making the films of this invention. Additives conventionally used in films may be incorporated, such as colorants, processing aides, surfactants and the like, depending on the needs of the particular applications.

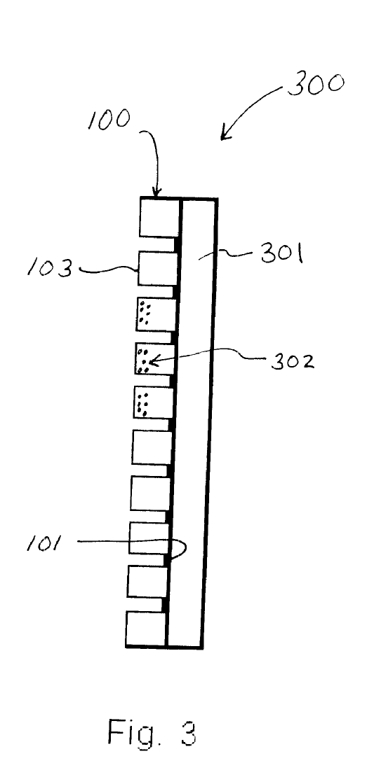

As mentioned above, the textured film of the present invention, in one embodiment, may be used to deliver active ingredients in a delivery system. Specifically, Applicants have found that the pockets of textured film are uniquely suited for holding active substances and to deliver the substances to the desired point of contact. Referring to FIG. 3, a preferred embodiment of the delivery system 300 is shown. As shown, the delivery system 300 comprises the textured film 100 as described above in addition to a second layer 301 applied to the first surface 101 of the textured film 100. The active substance 302 is located within the pockets 102. The second layer 301 serves to contain the active substance within the pocket 102. The configuration of the delivery system FIG. 3 can be used in various applications.

When functioning as an applicator, the second layer 301 is preferably a material suitable to allow the active substance to flow out of the pockets 102. Suitable materials for layer 301 include, for example, a fabric of woven or nonwoven fibers, an apertured film, or combinations thereof. Commonly used active substances 302 may include, for example, liquids for application to the skin (e.g. topical medications, sunscreen, skin lotions, soap, insect repellent), and cleaning agents for application to surfaces for cleaning (e.g., solvents, detergents).

In practice, the user applies the second layer 301 to the target surface requiring application of the active substance and applies pressure. This pressure causes the pockets 102 to deform, thereby expelling the active substance through the second layer 301 and onto the target surface. Once the user stops applying pressure, the pockets regain their original shape and thus no longer expel the active substance through the second layer 301.

The textured film 100 of the invention may also be used to hold a reactive substance. For example, a color change indicator can be placed in the pocket which will provide a visual indication that it has reacted with a target substance. In another embodiment, the reactive substance can be an absorbent material, such as activated charcoal or a super absorbent polymer (“SAP”). When using SAP, the film 100 containing the SAP can be placed in a diaper or absorbent undergarment in the precise area in which the absorbent feature is desired, that is, the area most likely to receive the insult of bodily discharge. This leads to more effective absorption, less bulk, and less waste.

In some embodiments for this application, a second layer 301 may preferably be a material suitable for allowing fluids (gasses and/or liquids) to pass through and reach pockets 102. In other embodiments, individual pockets could contain different reactants which are released and mixed upon crushing the pockets. Accordingly, materials used for the second layer 301 described above for the applicator could apply to this embodiment as well.

In yet other embodiments, the film 100 of the invention may be used to control plant growth and lawn or garden pests. Accordingly, the active substance contained in the pocket 102 may be an insecticide, an herbicide, and/or a fertilizer. The second layer 301 of this embodiment may allow for the flow of the active substance from the delivery system, or, it may be configured to simply contain the active substance until such time that the pockets 102 are breached by plant or insect life, or the film 100 may be made of a biodegradable or compostable polymer that releases the substance from the pockets as the film deteriorates.

The textured film 100 of the present invention may also be used as a cushion. That is, if the relatively deep pockets 102 of the textured material 100 are filled with a fluid or fluid-like material such as air, liquid or gel, they can act as a shock absorber, thereby facilitating the material's use in such applications as floor underlayment, footwear and other applications where cushioning is needed. In this application, it is preferable that the material used be relatively tough such that the bottom 103 of the pockets 102 do not rupture. One skilled in the art, in light of this disclosure, can readily determine the proper material and thickness needed to achieve the desired degree of toughness for the particular application.

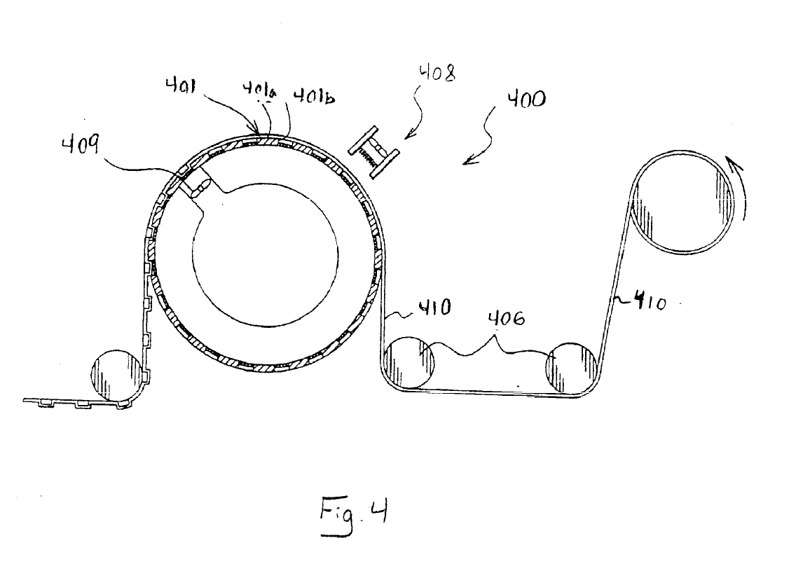

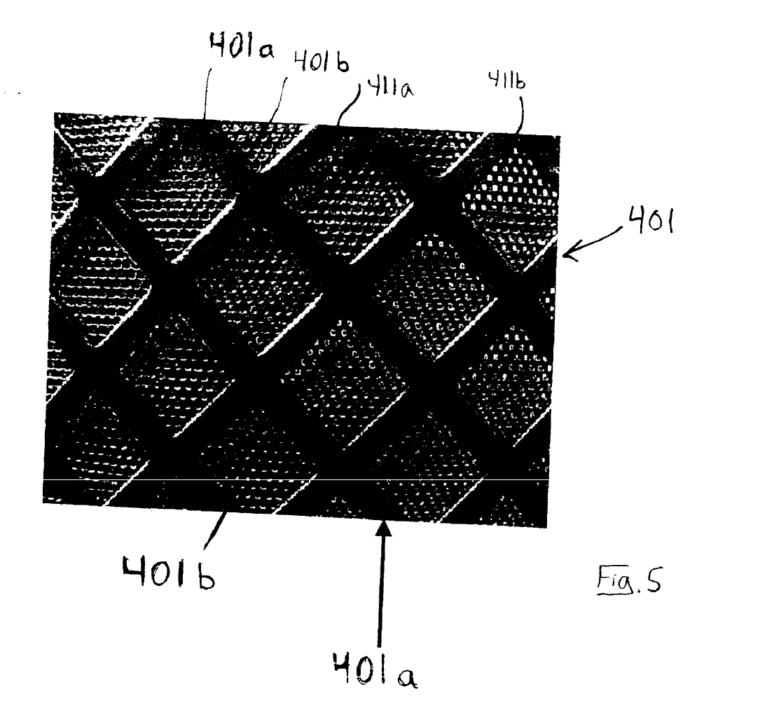

FIGS. 4 and 5 illustrate an apparatus 400 for making the texture film 100 according to a method of this invention. The method comprises (1) providing a suction roll having a first tool defining voids and a second tool disposed within said first tool and defining a texture within said voids; and (2) contacting a web of polymeric film with said suction roll to draw said web onto said first and second tools, whereby the voids create pockets in a first surface of said web having a thickness, each pocket having a textured bottom created by said texture of said second tool, and wherein each bottom has a thickness less than the thickness of said first surface. The process may be a re-heat process, wherein a pre-manufactured film is heated above its softening point prior to contact with the suction roll, or a direct cast process wherein a film of molten polymer is brought into contact with the suction roll.

With reference to FIG. 4, a re-heat process 400 is illustrated therein. As illustrated, a roll of plastically deformable sheet material 410 is unwound and fed to a screen mold 401 which is in the shape of a cylinder or drum. FIG. 4 illustrates a series of rollers 406, which are typically employed as drive or idler rollers in a film manufacturing process.

The screen mold 401 includes a first screen element 401a and a slightly smaller diameter second screen element 401b. The second screen element 401b is disposed within and connected to the first screen element 401a. With reference to FIG. 5, the first and second screen elements 401a, 401b are formed with a plurality of first and second screen holes 411a, 411b, respectively (see FIG. 5). Each of the first screen holes 411a have a cross-section greater than those of the second screen holes 411b and each of the first screen holes 411a spans at least one of the second screen holes 411b. The screen mold 410 may be heated or cooled by means known in the art as required for the particular film being prepared.

In a reheat process such as that depicted in FIG. 4, at least one heater element 408 is employed to heat the film 410 above its softening point. Such a heater element is generally not necessary in a direct cast process. The film 410 is then carried by the screen mold 401 and a negative pressure (i.e., vacuum 409) is applied to the softened film 410 from the inside of the screen mold 401. The negative pressure draws the film 410 against the first and second screen elements screen so as to form the pockets that respectively correspond to the first screen holes 411a and so as to form the textured second surface 104 that respectively correspond to the second screen holes 411b.

What is claimed is:

1. A textured film having a first surface defining a plurality of pockets, each pocket having a bottom with a thickness less than that of said first surface.

2. The device of claim 1, wherein said pockets are arranged in a pattern and wherein said pockets are of substantially equal size.

3. The device of claim 1, wherein each pocket has a textured second surface at said bottom.

4. The device of claim 3, wherein said second surface is continuous and not apertured.

5. The device of claim 4, wherein said second surface has a texture of 20-60 cells per linear inch.

6. The device of claim 3, wherein the texture on said second surface has a z-direction delta and wherein the ratio of depth to said delta is about 1.5 to about 5.

7. The device of claim 1, wherein said film material is selected from the group consisting of polyolefins, polyamides, polyesters, polyvinylchlorides, and polyacrylic acids.

8. The film of claim 1, wherein the film is selected from the group consisting of biodegradable and compostable films.

9. A device comprising a textured film having a first surface defining pockets and a second layer overlaying said first surface.

10. The device of claim 9, wherein at least one of said pockets contains an active substance and wherein said second layer is selected from the group consisting of a woven fabric, a nonwoven fabric, a film and combinations thereof.

11. The device of claim 10, wherein said active substance is selected from the group consisting of cleaning agents, scents, solvents, skin lotions, sun screens, topical medications, reactive substances, neutralizing agents, antimicrobial agents, and mixtures thereof; wherein each pocket has a bottom having a thickness less than that of the first surface; and wherein said device is constructed to deliver said active substance upon the application of pressure.

12. The device of claim 10, wherein said active substance is selected from the group consisting of reactive chemicals, activated charcoal, neutralizing agents, antimicrobial agents, super absorbent material, and mixtures thereof and wherein said device is constructed to absorb fluids into at least one of said pockets.

13. The device of claim 10, wherein said active substance is selected from the group consisting of insecticides, herbicides, fertilizers, and mixtures thereof and wherein said device is constructed to release said active substance under predetermined conditions.

14. The device of claim 10, wherein said active substance comprises at least one substance selected from the group consisting of gasses, gels, and liquids and wherein said device is constructed to retain the active substance when said device is subjected to pressure.

15. The film of claim 1, wherein the film is selected from the group consisting of biodegradable and compostable films.

16. A method of making a textured film, comprising (1) providing a suction roll having a first tool defining voids and a second tool disposed within said first tool and defining a texture within said voids; and (2) contacting a web of polymeric material with said suction roll to draw said web onto said first and second tools, whereby the voids create pockets in a first surface of said web having a thickness, each pocket having a textured bottom created by said texture of said second tool, and wherein each textured bottom has a thickness less than the thickness of said first surface.

17. The method of claim 16, wherein said first and second tools are discrete cylindrical members, one disposed within the other.

18. The method of claim 16, wherein said first and second tools are integrally formed.

19. The method of claim 16, wherein said web of polymeric material comprises a film and wherein said process further comprises heating said film above its softening point.

20. The method of claim 16, wherein the web of polymeric material comprises a molten polymer curtain.
